(19) United States
(12) Patent Application Publication
(10) Pub. No.: US 2015/0324756 A1
(43) Pub. Date: Nov. 12, 2015

(54) INTEGRATED, FLEXIBLE ELECTRONIC CALENDAR SYSTEM WITH DYNAMIC PERMISSIONS AND SHARING FUNCTIONALITY

(71) Applicants: Daniel HUGHES, North Richland Hills, TX (US); Danielle COCANOUGHER, North Richland Hills, TX (US); Charles Daniel COCANOUGHER, North Richland Hills, TX (US)

(72) Inventors: Daniel HUGHES, North Richland Hills, TX (US); Danielle COCANOUGHER, North Richland Hills, TX (US); Charles Daniel COCANOUGHER, North Richland Hills, TX (US)

(21) Appl. No.: 14/698,435

(22) Filed: Apr. 28, 2015

Related U.S. Application Data
(60) Provisional application No. 61/985,147, filed on Apr. 28, 2014.

(51) Int. Cl. G06Q 10/10

(52) U.S. Cl. CPC G06Q 10/1095

(57) ABSTRACT

A system and method for establishing and maintaining a shared, flexible electronic-calendar network with varying permission, notification, sharing, and functionality options, and a user interface from which the user can manage multiple electronic calendars.

### RELATED APPLICATION DATA

This application claims priority from U.S. Provisional Application Ser. No. 61/985,147 filed on Apr. 28, 2014, the content of which is hereby incorporated in its entirety.

### BACKGROUND OF THE INVENTION

1. Field of the Invention

The present invention generally relates to the field of electronic calendars and, more particularly, to an integrated, flexible, electronic calendar system that enables users and groups to easily create, maintain, and share multiple calendars and events specifically tailored and optimized to the particular needs of the user or group.

2. Description of the Related Art

Electronic calendars, or e-calendars, are commonly used in business organizations to schedule and manage work events. Most e-calendars used in the workplace are tailored to a corporate environment, prioritizing standardization, control, and consistency over flexibility and user-friendliness. For example, in a typical e-calendar, if a user creates an event on her calendar and invites another user to the event, the invitee generally has no ability to modify the details of the event.

Many people who use e-calendars for work do not maintain separate e-calendars for their personal life. One reason for this is that e-calendars designed for personal use still maintain much of the rigidity and inflexibility of workplace e-calendars. Therefore, many people simply use their work e-calendar to schedule and manage personal events as well. This creates a problem for users and groups who would like to have more flexibility in the creation, management, and sharing of events than typical work e-calendars offer. Moreover, using a single e-calendar to manage and schedule each aspect of one's life has significant privacy implications.

A person who does keep separate e-calendars faces substantial integration and management problems when dealing with calendars made by different companies, for different purposes, and with different permissions, sharing, and other functionality. For example, consider an individual who uses Microsoft Outlook™ at work and keeps a separate iCal™ calendar for personal use. To add a work event to her personal calendar, the individual would need to manually update the personal calendar. If the start time of the work event was later modified, she would need to manually update the start time of the work event in her personal calendar to maintain accuracy.

### BRIEF DESCRIPTION OF THE DRAWINGS

FIG. 1 is a flow chart depicting the logic flow of an embodiment of the invention.

FIG. 2 is a permission chart for a private calendar for an embodiment of the invention.

FIG. 3 is a permission chart for a public calendar for an embodiment of the invention.

FIG. 4 is a sharing notification chart for a private calendar for an embodiment of the invention.

FIG. 5 is an edit notification chart for a private calendar for an embodiment of the invention.

FIG. 6 is permission/notification chart for a private calendar for an embodiment of the invention.

FIG. 7 is a sharing notification chart for a public calendar for an embodiment of the invention.

FIG. 8 is an edit notification chart for a public calendar for an embodiment of the invention.

FIG. 9 is permission/notification chart for a public calendar for an embodiment of the invention.

FIG. 10 is a screen shot of a view in the user interface in an embodiment of the invention.

### SUMMARY OF THE INVENTION

Disclosed is a system (and related methods) for viewing and managing a user's collection of electronic calendars. Some embodiments of the system include a user interface that allows the user to browse through a collection of electronic calendars, and to add or remove electronic calendars from the user's collection. This collection can include a combination of calendars that the user created and calendars created by other users. In some embodiments, the system further includes a permissions set that enables the owner of a particular calendar to allow other users to view, add to, share, and/or edit that particular calendar.

In a further embodiment, a system for viewing and managing a collection of electronic calendars of a user, comprises: an interface that enables the user to browse through the collection of electronic calendars and add or remove electronic calendars from the collection of electronic calendars; and a permissions set that enables an owner of a particular electronic calendar to allow others to at least one of view, add to, share, and edit the particular electronic calendar.

In some embodiments, the system allows the user to link an event from one electronic calendar into a second electronic calendar. Afterwards, the event is “linked” to the first calendar such that when the event information is modified in the first electronic calendar, the event is automatically updated in the second electronic calendar. For example, a user with a work calendar and a personal calendar can link work events into his personal calendar; and when the event is updated in the work calendar, it is automatically updated in the personal calendar, as well.

In some embodiments, the system allows the owner of a calendar to share that calendar with other individuals, and to allow those other individuals to share the calendar with third parties, ad infinitum. Further, in some embodiments, the owner can let those individuals specify permissions for those third parties (not exceeding the permission level granted by the owner to those individuals).

In some embodiments, the permissions set further enables the owner of a particular electronic calendar, or another individual with the requisite permissions, to set specific permissions for individual events in the calendar. Therefore, within the same calendar, certain individuals may be able to edit some events, but only view others, etc.

In some embodiments, a calendar that is present in multiple users' collections of calendars is configured such that a modification to that calendar (or to the individual events) is automatically reflected in each of the users' collections of calendars.

In some embodiments, the system further comprises a dynamic notification component that allows various levels of notification based upon the importance of a calendar update.

In some embodiments, the system further comprises an estimated time of arrival (“ETA”) component that updates attendees of a meeting with location information (based on GPS data, etc.) of other attendees of the meeting. Some embodiments allow users to include this functionality in some calendars or events, but not others. Some embodiments allow users with requisite permissions to selectively apply this functionality to certain event attendees or certain users sharing the calendar. Some embodiments further enable individuals to decline the ETA functionality (such that other individuals cannot see their location) in totality or for a particular meeting or calendar.

In some embodiments, the system further comprises a chat component that enables users with requisite permissions to discuss an event or multiple events on the electronic calendar. Some embodiments allow users to include this functionality in some calendars or events, but not others. Some embodiments allow users with requisite permissions to selectively apply this functionality to certain event attendees or certain users sharing the calendar.

In some embodiments, users can create either private or public calendars. Some embodiments include different default permissions for private calendars as compared to public calendars. In some embodiments, public calendars can be searchable by the general public. In further embodiments, some public calendars that are searchable cannot be fully viewed, shared, etc. by an individual unless the individual agrees to conditions and/or pays a fee.

Some embodiments allow users to search within a particular calendar, using a search function, to find particular events or a subset of events.

In some embodiments, the system comprises viewing and managing a collection of electronic calendars of a user, comprising: an interface that enables the user to browse through the collection of electronic calendars and add or remove electronic calendars from the user collection of the user; and a permissions set, that enables an owner of a particular electronic calendar to allow others to perform the following permissions, selected from the group consisting of: view the particular electronic calendar; add to the particular electronic calendar; view and add to the particular calendar; view and share the particular electronic calendar; view, add to, and share the particular electronic calendar; view, add to, and edit the particular electronic calendar; or view, add to, share, and edit the particular electronic calendar; and combinations thereof.

The disclosed contemplated embodiments of the invention overcome deficiencies of conventional systems by enabling users and groups of users to easily create various e-calendars with a wide range of permission, sharing, linkage, notification, and functionality options that enable the owner(s) to create an e-calendar narrowly tailored to the particular needs of the individual or group. Thus, a single, dynamic e-calendar creation and management system is provided for creating and/or integrating e-calendars for a wide range of purposes and for groups of varying sizes, such as individuals, co-workers, families, groups of friends, colleges, church groups, charities or sports teams.

Embodiments of the invention can be implemented on numerous types of electronic devices such as mobile phones, PDAs, laptops, personal computers, tablets, and other electronic devices that have a processor and memory.

### DETAILED DESCRIPTION OF THE EXEMPLARY EMBODIMENTS

Disclosed is a dynamic, flexible e-calendar creation and management system that includes an interface that allows users to easily view, manage, and modify a collection of e-calendars. Multiple embodiments of the invention are envisioned. Specific embodiments discussed below should not be read to limit the scope of the invention to those particular embodiments.

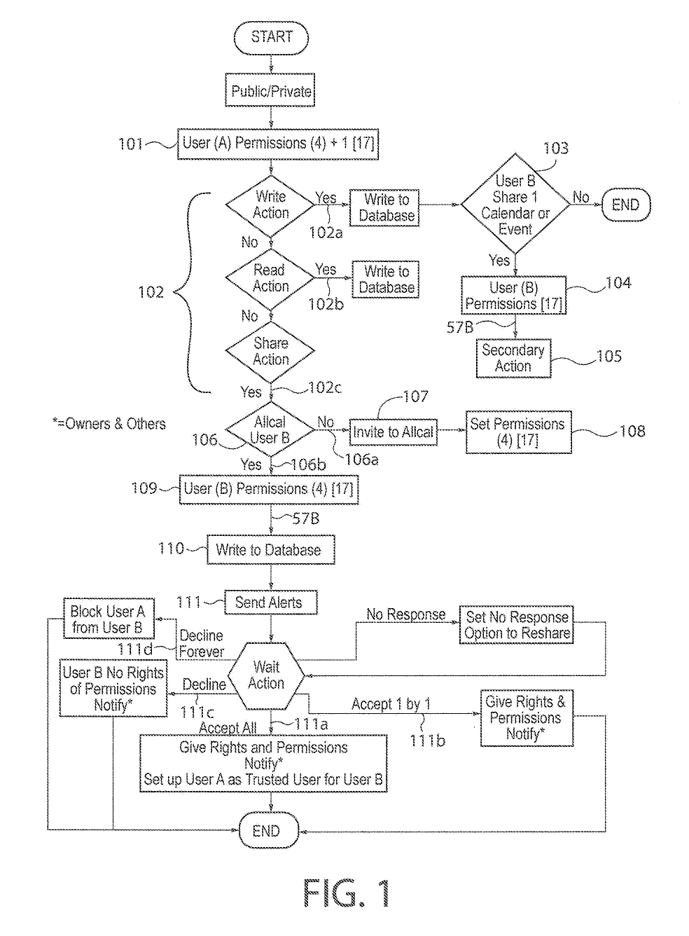

FIG. 1 is a flow diagram depicting the logic flow of an embodiment of the invention. As shown in FIG. 1, when User A performs an action on a public or private calendar, the system identifies the permissions of User A at step 101, and then identifies at step 102, whether the intended action is a write action 102a, read action 102b, or share action 102c, and performs the corresponding allowable action. In the instance of a write action 102a, the system checks at step 103 whether the calendar or event written to is shared with other users, such as User B. If so, the system checks at step 104 User B's permissions and, if allowable, performs a secondary action for User B at step 105.

In the instance of a share action 102c with User B, the system first checks at step 106, whether User B is a user of the system. If not 106a, the system invites User B at step 107 and, if User B accepts, User B shares User A's particular calendar (or event) in accordance with the permissions set by User A at step 108. If User B is already a user of the system 106b, the system initiates the share action 110 in accordance with User B's permissions 109 set by User A. The system initiates alert options 111 for User B in accordance with whether User B has decided to accept all share actions 111a from User A, accept share actions on a case-by-case basis 111b, decline the particular share action 111c, or decline all share actions 111d from User A.

The basic logical structure of the method depicted in FIG. 1 allows for the full integration of shared calendars such that calendars that are included in multiple users' collections of calendars can be automatically updated in accordance with the permissions set for that particular calendar, event, and/or user. In other words, different users see the same instance of the linked calendar. In some embodiments, automatic updates via linkage only occur for a particular user's version if the permissions for the calendar, the event, and/or the user allow for the automatic update.

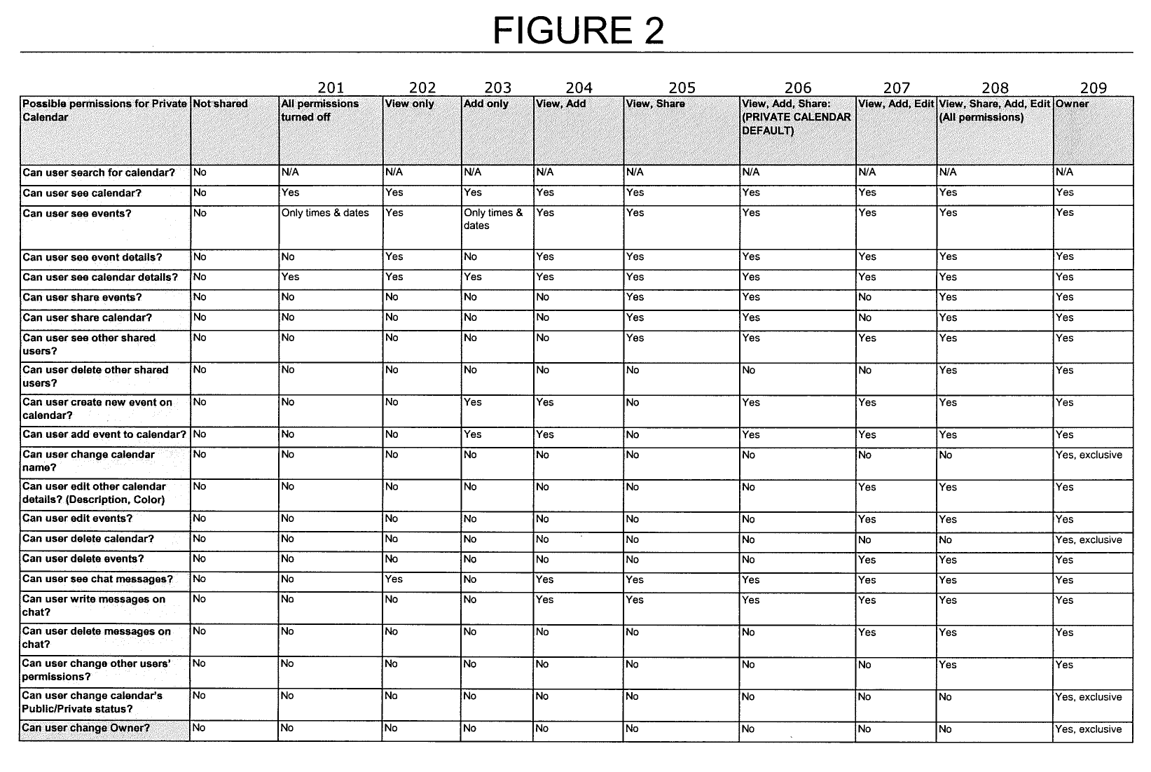

FIG. 2 is a chart describing the permissions for a private calendar in an accordance with an embodiment of the invention. As shown in FIG. 2, each calendar and/or event can have View, Add, Share, and Edit permissions. For example, if User A's calendar has all permissions turned off 201 for User B, then User B can only see the dates and times of the events in User A's calendar, not the details of those events. If User B has View permissions 202, User B can see the details of User A's events. If User B has Add permissions 203, User B can add events to User A's calendar. Other combinations of these permissions and additional permissions are contemplated. For example, FIG. 2 shows that User B is allowed to write messages on chat if User B has both View and Add permissions 204, but not if User B has only one of these two permissions. In other embodiments, User B can write chat messages without Add permissions. In still other embodiments, User A may override permission defaults such that User B can write messages on chat without Add permissions. Other embodiments include specific permissions for each type of functionality, such as chat or ETA.

Returning to FIG. 2, if User B has View and Share permissions 205, User B can share User A's calendar with others, see other shared users, and utilize chat functionality.

As further shown in FIG. 2, the View, Add, and Share permissions 206 are the default permissions for a private calendar. If User B has these default permissions, User B can see event details and other users, create new events and add these newly created events to User A's calendar, and engage in chat functionality.

If User A wishes to give User B more control of the calendar, User A can give User B Edit permissions on User A's calendar. For example, as depicted in FIG. 2, with View, Add, and Edit permissions 207, User B cannot only add events to the calendar, but also edit or delete existing events. User B can also see shared users. However, in this scenario, permissions B would not be able to share the calendar because User B does not have Share permissions.

If, in addition to View, Add, and Edit permissions, User B also has Share permissions 208, the chart of FIG. 2 shows that User B is allowed to do everything except for change the calendar name, change the owner, change the private/public status of the calendar, or delete the calendar altogether. Only the calendar owner 209 has these abilities.

In some disclosed embodiments of the invention, it is also possible to apply each permission to individual events in the calendar. For example, a user may set her work calendar so that nobody outside the workplace can view events during the workday, but after-hours events are viewable or even sharable by others. Alternatively, the user can give only some people edit permissions for some events and only other people edit permissions for other events. The combination of permission options and the ability to apply these permissions at the calendar or event level for each user results in an unlimited number of possibilities and introduces a high degree of flexibility that allows users to craft their calendars and events to meet their specific needs.

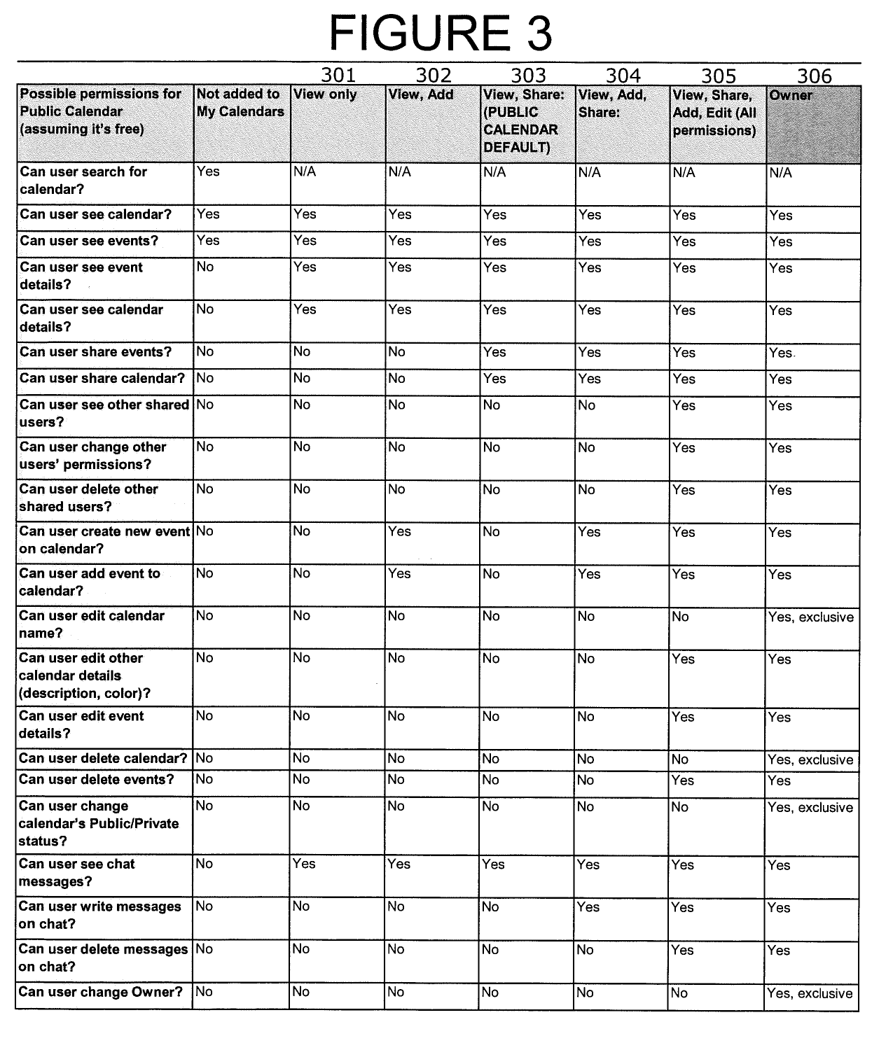

FIG. 3 is a chart describing the permissions for a public calendar in an accordance with a further embodiment of the invention. As shown in FIG. 3, the default permissions for a public calendar are View and Share 303. Here, only the Owner 306 or a user with all permissions 305 can change other users' permissions. For example, the Owner 306, can restrict a user's permissions to only View 301 or expand the user's permissions to include View, Add, and Share 304. Alternatively, the Owner 306 has the option to change the user's permissions to View and Add 302. In some embodiments, a user of the system can search for a specific public calendar on the system either by calendar name or through a search feature. In further embodiments, the search feature factors in location and popularity to decide which public calendars are initially shown, or whether these calendars are even shown.

With the default permissions of FIG. 3, public calendars operate in the following exemplary manner . . . . It should be understood that the public calendars may operate in other ways, and it is not the intention to limit the invention to the presently described example. Thus, User A searches the system for a Texas Rangers calendar and downloads the calendar to his mobile device. User A can view the Texas Rangers calendar because User A has View permissions. User A also has Share permissions, which allows User A to share the calendar with User B. When User B accepts, User B will also have View and Share permissions. User B then shares the calendar with User C. When User C accepts, Users A, B, and C each have a version of the calendar on their electronic device(s). Users A, B, and C decide to attend a particular game together. To facilitate this, Users A, B, and C each link the calendar event for that game into their personal calendar. If the Texas Rangers calendar changes (e.g. the game is postponed by an hour), the calendar event for the game is automatically updated on each version of the Texas Rangers calendar viewable by the three Users. In addition, each respective personal calendar of the three Users is updated with the event change. In some embodiments, the personal calendar would still be updated, even if each User removed their version of the Texas Rangers calendar, because the event that was linked to their personal calendars is still linked to the Texas Rangers calendar. Accordingly, Users A, B, and C are nevertheless notified of the change in the event.

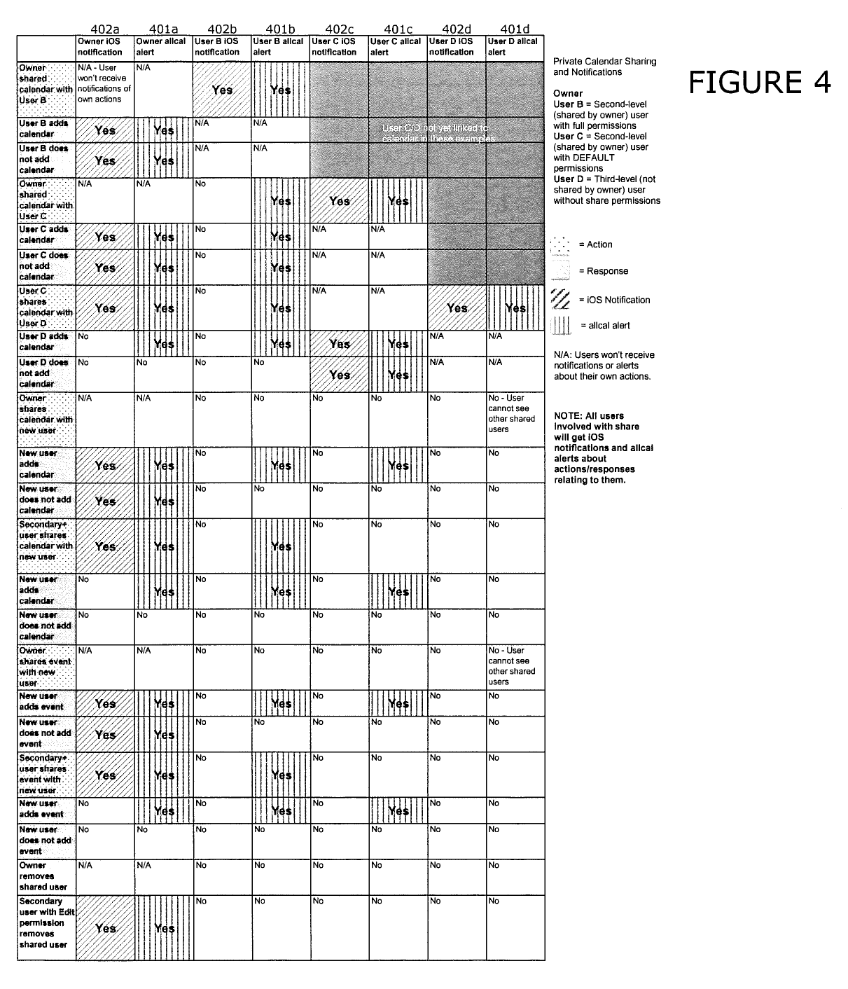

FIGS. 4-9 show notification tables in accordance with the disclosed embodiments of the invention. In these embodiments, different actions will produce different types of notifications, such as application-based alerts, iOS notifications, and limited versions of each. The level of notification depends upon the relative importance of the update.

In particular, FIG. 4 depicts a sharing notification table for a private calendar in accordance with an embodiment of the invention. As shown in FIG. 4, User B will receive an allcal alert 401b and an iOS notification 402b when the User shares a calendar with User B, giving User B full permissions. When User B responds by either adding or declining to add the calendar, the Owner receives an allcal alert 401a, as well as an iOS notification 402a. The Owner may also share the calendar with User C, giving user C default permissions. User C, in turn, may share the calendar with User D, without share permissions. If the Owner then shares the calendar with a new User, who adds the calendar, User C would receive an allcal alert 401c, but not an iOS notification 402c. User D, however, would not receive either an allcal alert 401d or an iOS notification 402d.

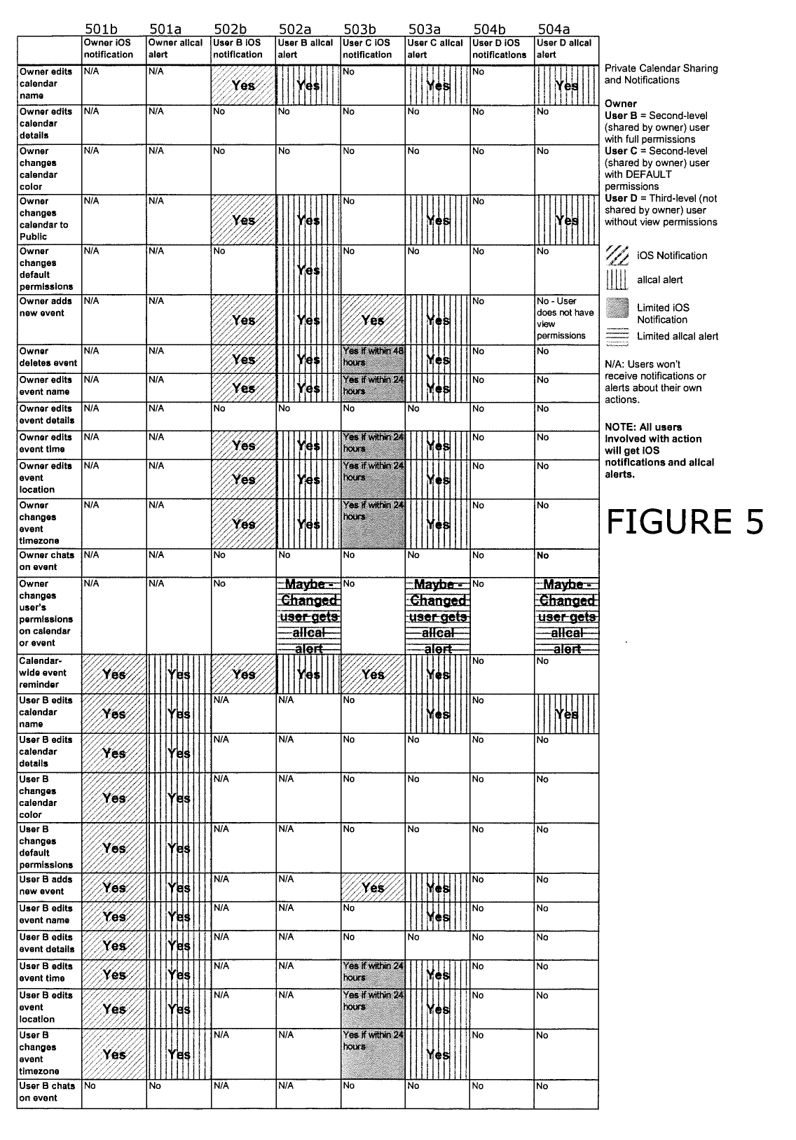

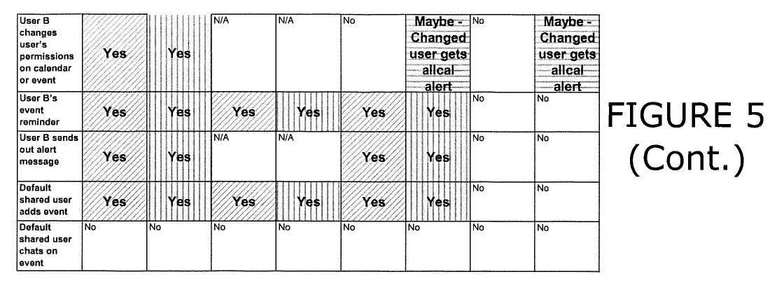

FIG. 5 depicts an edit notification table for a private calendar in an embodiment of the invention. As shown in FIG. 5, the Owner has shared a calendar with User B and User C, where giving full permissions and default permissions, respectively. In turn, User C has shared the calendar with User D, who does not have view permissions. With further reference to FIG. 5, if the Owner deletes an event, User B receives both an allcal alert 502a and an iOS notification 502b. User C also receives an allcal alert 503a, but only receives an iOS Notification 503b, in limited circumstances, such as if the event is within 48 hours. User D, however, would receive neither an allcal alert 504a nor an iOS notification 504b. As also shown in FIG. 5, the Owner of the calendar usually receives both an allcal alert 501a and an iOS notification 501b when users make changes to the calendar, such as adding a new event or changing an event location.

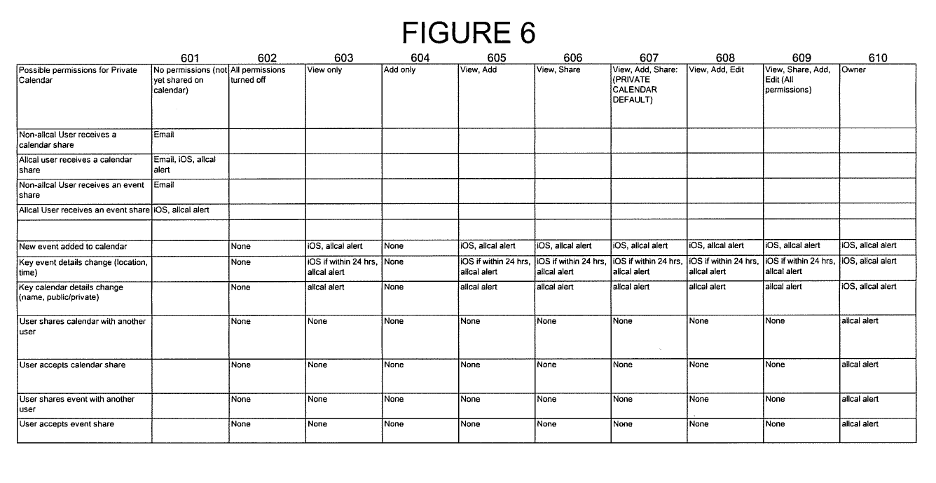

FIG. 6 depicts permissions for a private calendar in accordance with an embodiment of the invention. The types of permissions shown in FIG. 6 are: no permissions 601, all permissions turned off 602, View only 603, Add only 604, View and Add 605, View and Share 606, View, Add, and Share 607 (which is the private calendar default in presently contemplated embodiment), View, Add, and Edit 608, View, Share, Add, and Edit 609, and Owner permissions 610.

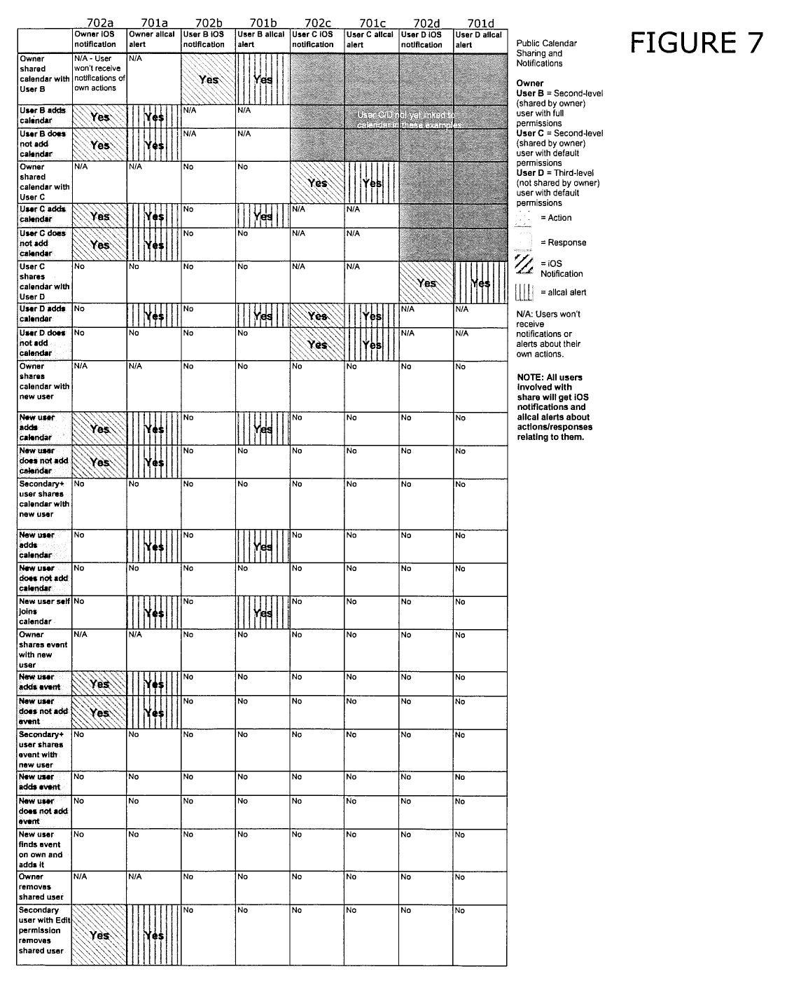

FIG. 7 depicts a sharing notification table for a public calendar in accordance with an embodiment of the invention. As shown in FIG. 7, User B will receive an allcal alert 701b and an iOS notification 702b when the User shares a calendar with User B, giving User B full permissions. When User B responds by either adding or declining to add the calendar, the Owner receives an allcal alert 701a, as well as an iOS notification 702a. The Owner may also share the calendar with User C, giving user C default permissions. User C, in turn, may share the calendar with User D, with default permissions, resulting in User D receiving an allcal alert 701d and an iOS notification 702d. If User D chooses to add the calendar, User C receives both an allcal alert 701c and an iOS notification 702c. However, the owner would receive an allcal alert 701a, but not an iOS notification 702a.

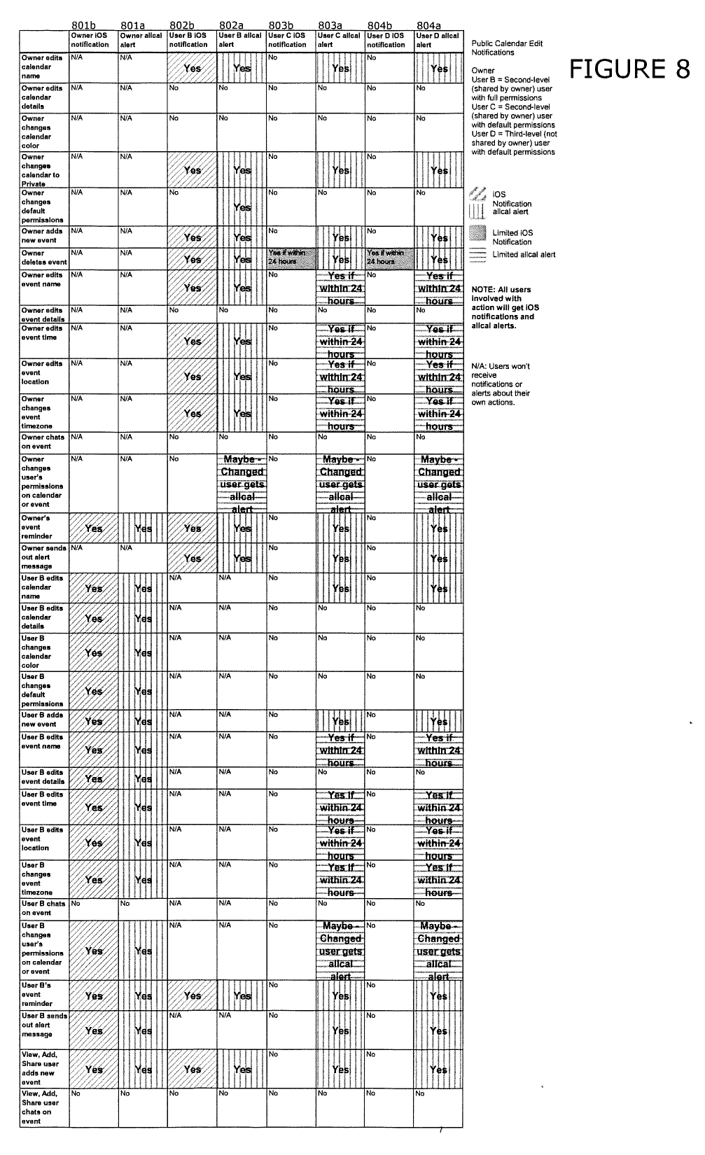

FIG. 8 depicts an edit notification table for a public calendar in accordance with an embodiment of the invention. As shown FIG. 5, the Owner has shared a calendar with User B, giving full permissions, and User C, giving default permissions. In turn, User C has shared the calendar with User D, with default permissions. In FIG. 8, if the Owner deletes an event, User B receives both an allcal alert 802a and an iOS notification 802b. User C also receives an allcal alert 803a, but only receives an iOS Notification 803b, in limited circumstances, such as if the event is within 48 hours. Similarly, User D, receives an allcal alert 804a, but only receives an iOS Notification 804b, in limited circumstances. In FIG. 8, the Owner of the calendar usually receives both an allcal alert 801a and an iOS notification 801b when users make changes, to the calendar, such as adding a new event or changing an event location.

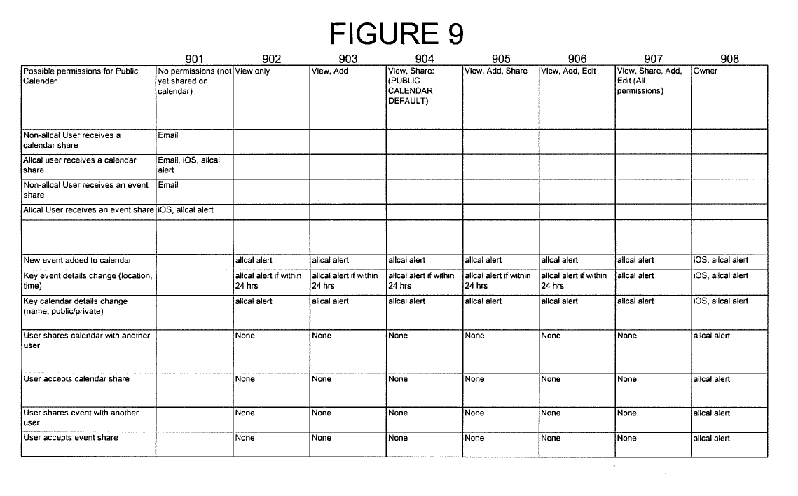

FIG. 9 depicts permissions for a public calendar in accordance with an embodiment of the invention. Here, the types of permissions shown are: no permissions (not yet shared on calendar) 901, View only 902, View and Add 903, View and Share 904 (which is the public calendar default in the embodiment of FIG. 9), View, Add, and Share 905, View, Add, and Edit 906, View, Share, Add, and Edit 907, and Owner permissions 908.

Other embodiments include more refined or additional tiers of notification, such as email, text messages or push notifications. In some embodiments, the notifications are fully or partially configurable by the user.

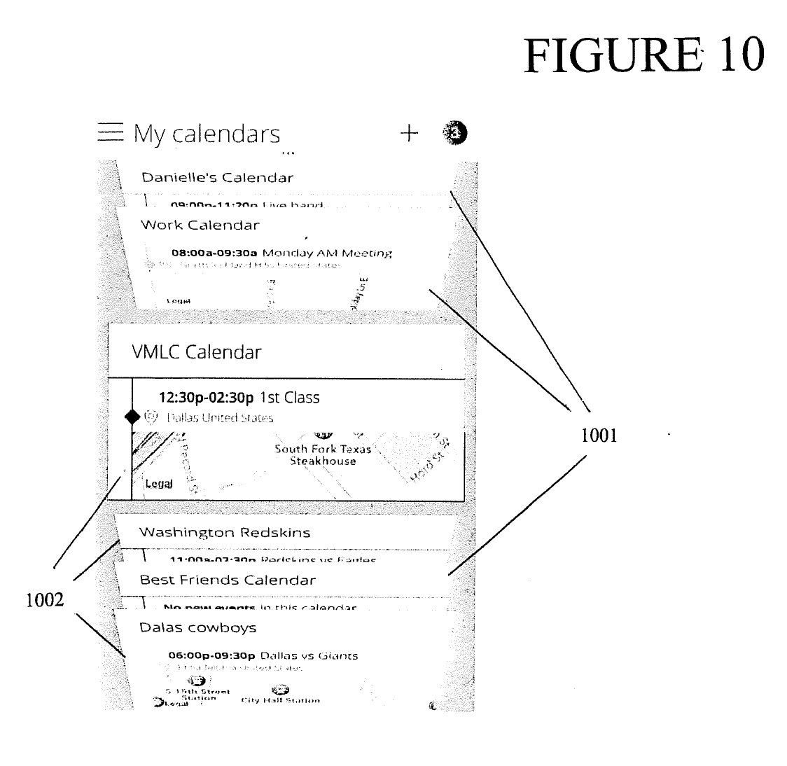

FIG. 10 depicts a screen capture of a view of the user interface in accordance with an embodiment of the invention. The screen capture of the user interface in FIG. 10 shows that the user has both private calendars 1001, and public calendars 1002. Disclosed embodiments of the invention allow for a user to view multiple calendars in her collection of calendars. This collection may include, for example, the user's personal calendar, her work calendar, her friend's private calendar that was shared with the user, and/or a public calendar of her favorite sports team. Events in these calendars can be linked to the original calendar in which they were created. For example, if the user's friend updates an event on his personal calendar, the event is also updated in the version seen by the user. Additionally, if the user had linked her friend's event into her own personal calendar, the event details would update there as well.

The following exemplary use cases depict the various ways that the flexible e-calendar system can be utilized for different sizes of groups and for different purposes. These examples are for illustrative purposes and should not be understood as limiting the scope of the invention in any way.

| | | Type of Group | Size of Group |
|---|---|---|---|
| Use Case | | [Public/Private] | [Small, Med, Large] |
| 1. | Single Family | Private | Small [2-12] |
| 2. | Friend's vacation | Private with Public | Small [3-10] |
| | together | aspects including | |
| | | photo/video/text | |
| | | sharing | |
| 3. | Alcoholics Anonymous | Public or Private | Large [MMs] |
| 4. | Toastmasters | Public or Private | Large [MMs] |
| 5. | Church (also Mega- | Public or Private | Medium [50-500] |
| | Church) | | |
| 6. | Sorority | Public or Private | Medium [50-250] |
| 7. | Hospital Stay | Public or Private | Medium to Large |
| | | | [250-1,000] |

| | |
|---|---|
| | Description: Consider a family of four, two |
| | spouses and two teenage kids. Each has an IOS |
| | device that they carry continuously with them. |
| | Each has their own lives to keep up with, and |
| Title: Single Family | yet they are all entwined. |

Details:
Father: One personal calendar, in which he allows spouse full access which is defined as
all permissions, but he maintains the basic owner rights. He also has rights to his
spouses' calendar with a read and write, but not edit, so he can see all her
appointments, and write new ones, but cannot edit other appointments he did not
write. Same read and write access, but not edit to both kids calendars.
Mother: One personal calendar, in which she allows her spouse to have read and write
permissions, and possibly read or limited read permissions to her kids. Limited read
would allow her kids to see only titles and dates/times, or possibly just dates/times, but
no descriptions or chat.
Kids: each has a personal calendar and some access to their mother's. They may or may
not have access to each other's.
All four will be capable of creating an event in their own calendar, and easily seeing the
other three, can invite any or all to the event.
The mother will be able to create an event in any person's calendar inviting any or all to
that event.
Each person opens their collection of calendars, and they see their particular schedule,
and can swipe to see the others in their family, or what part of it they are allowed.
Start with one simple invite from one family member to each ones email, and they select
option to automatically accept all invitations from that user “accept - Always,” plus they
download the app and put in their name, password, and email to begin their account. It
should be mentioned here that accepting invites does not mean you are attending the
event. Attending is a separate matter that can be addressed later.

| | |
|---|---|
| | Description: Consider five persons that are |
| | traveling together on a vacation. They need |
| | something to coordinate what they are doing |
| | and when. They will use an embodiment of |
| Title: Friends' Vacation Together | the invention. |

Details:
Each person has their own personal calendar, but they are only going to use the single
vacation calendar that one of them sets up and give each person either full access or
read/write access to all events and communications.
If any one person thinks of something they want to do, they can propose it by writing the
event, and in the description saying it is a proposition, what does everyone think? Then
each person may immediately see this event and communicate through chatting.
Once events are in place, all parties may chat on the calendar itself and on individual
events.
Any change to the event's time or schedule will be immediately seen by all five persons
When an event is near - say 1 hour before - any person can look at the event and see
the other four and how much travel time they have to the event. This is complicated,
and usually done when invited to a specific event, and this is the entire calendar that
each has been given access to. Alternatively, this may only work when the individual
members are invited to a particular event, which is quite possible.
To begin with, one person creates the calendar and it is a Private Calendar (not personal
or public) and then that person invites with appropriate access the other four people to
gain access and privileges to this calendar.
Why are we creating a new calendar, rather than just inviting each other to all the events
from our personal calendar. Because of rights and permissions. Because in real life, it is
separate. This calendar represents something different and separate than our personal
calendar. Same thing for a school calendar, or work calendar.
Each person accesses the system and if the last time they were looking at this private
calendar, then it comes up where they left it. It functions as much as possible the same
as a personal calendar that everyone has complete access to.
Each person, if allowed knows who else has access to it
References and Notes:
The 5 person vacation can be similar to any group, such as a book club or soccer team,
etc.
Picture and video sharing throughout the trip to that group. The user can (a) invite
family and friends to the calendar of the trip to show them their photos and videos;
and/or, (b) user can either select option for calendar system to automatically send all
trip photos and videos to Facebook, twitter, other social media or user can select and
post specific photos and videos to Facebook, twitter, etc. to lessen the steps to do both.
Attach geo location to each photo and video

| | |
|---|---|
| | Description: A member of AA who travels |
| | frequently for business and leisure wants to be |
| | able to maintain his daily AA meetings. Finding |
| | meetings in new locales takes searching on |
| | AA.com and/or calling for information on time, |
| Title: Alcoholics Anonymous | location and focus of meetings. |

Details:

| | |
|---|---|
| 1. | User loads the “Global AA Calendar” by searching via keywords for “Alcoholics |

| Anonymous” and because this is a public calendar, user is able to add it to his or her | |
|---|---|
| collection of calendars. | |
| a. | Public Organizations/Groups can “advertise” their group calendar to (1) everyone; or, |
| | (2) contextually appropriate individuals, that are users of the system to “load their |
| | calendar”. A user can simply click on the banner ad which will load the calendar into |
| | that users' account. This functionality for “one click add of a public group calendar” |
| | can be extended to any banner ad on the internet. If you are a “member” of the |
| | system, it will simply add to your account; but, if you are not a member, following |
| | the initial ad click, you are taken to the normal sign-up screen. Following sign-up, the |
| | group calendar you wanted to add will be automatically added. |

| 2. | When a user is planning a trip, they can either proactively (a) search by city, state, |
|---|---|
| | country; (b) search via zip code/postal code for meetings; (c) search near an address [i.e., |
| | their hotel, office, etc.] for the nearest meeting; or, reactively find the nearest meeting |
| | to them by initiating the “find the closest meeting” based upon parameters of meeting |
| | type (i.e., open/closed, group share, etc.) |
| 3. | When the meeting location is found, it will display the days/times of meetings and “type |
| | of meeting”. |
| 4. | The user will click the meeting they want to attend. If it is an open meeting, the meeting |
| | data is added to their calendar; or, if it is a closed meeting (requires an invite or |
| | “authorization” for attendance), it will send a “request to attend” to the meeting |
| | organizer and they can approve. Once approved, the meeting is added to the users' |
| | calendar. |
| 5. | Reminders, Alerts and updates are sent in the same fashion as normal. |
| 6. | When an AA member attends a meeting, they can one-click connect to other members |

only with their approval. This supports the ability to “call a friend” when needed. The
ability to contact members of a calendar or attendees of an event is configurable by the
owner of the event or others with requisite permissions.

Reference and Notes:

The events could be linked to digitized AA materials and even contextualized to the
type of meeting.
Because the user account is secure, it will maintain anonymity.

| | |
|---|---|
| | Description: A user of the system wants to find |
| | and attend Toastmasters' meetings in her area |
| | and other areas she travels to. She also wants |
| | to increase her opportunity to learn from other |
| | members by reviewing videos of herself and |
| | others presenting with feedback and score |
| Title: Toastmasters | from fellow members. |

Details:

| | |
|---|---|
| 1. | Duplicate most of the approach with AA. |
| 2. | Features during the meeting: |

| | |
|---|---|
| a. | Ability to video speakers and upload those speeches to the “sub-group” (only those |
| | in attendance at that particular meeting) which would require RSVP/Check In by each |
| | attendee to receive these videos. |
| b. | Ability for each attendee to rate each video with a Likert Scale with additional notes |
| | to support the speaker's performance if they would like to add. |

Reference and Notes:

Toastmasters could categorize, rank, rate and file these videos for broader use
(assuming permissions approved) within the Toastmaster community creating
further interactivity between members globally. This could turn into the “platform”
for entries into the toastmaster competitions.

| | |
|---|---|
| | Description: |
| | Churches have a need/demand to maintain |
| | and communicate schedules of services, |
| | church school classes (e.g. Sunday School and |
| | other classes), groups including teens/youth |
| | groups, young children, choir and choir |
| | practices, elderly, ladies group, external groups |
| | that meet within the church including boy |
| | scouts, day care, AA/NA, etc. For some events |
| | such as Sunday services, special services |
| | including Christmas and Easter holidays, there |
| | is a need to consistently communicate to the |
| | entire congregation at a public level the details |
| | of these events. For the other “sub-groups”, |
| | for which some are private, additional |
| Title: Church (Mega-Church) | calendars are needed. |

Challenges that churches' have that embodiments of the invention can address, include:

Quick and effective communication of closures of part/all of the church facilities due to
weather and other unplanned for events.
To reserve and communicate the reservation of facilities such as rooms, kitchen, organ,
piano, administrative services and resolve conflicts.
Easily create and administer public calendars on the Church website
Offer visibility and “control” of church facilities in a central manner by the pastor and
administrative staff and volunteers.

Public Calendar events that would be built include the following. This “Main Church Calendar”
could be displayed on the church's website and maintained by a volunteer(s) and/or a church
administrator.

Sunday Service(s)
Wednesday Service(s)
Sunday school classes
Special holiday Services - Christmas, Easter, etc.
Days/Times when the church is open and closed
Days/times when the church office is open
Funeral Services - when the family desires it be public
Wedding Services - when the family desires it be public
Christenings/Baptisms - when the family desires it be public.
Organizations that hold their meetings at the church facilities including: AA/NA, Boy
Scout and Girl Scout troops, Ladies Club, etc. (NOTE: some of these groups will be open
and desire their calendar to be public and others will not and desire their calendar to be
private or privileged; however, there can be an “administrator view” of the church
facilities to show availabilities and bookings.)
Onsite day care center - facility and human resources that serve the day care facilities'
availability and any schedule/resources changes
Special public events such as a voting location, reception for a school team or group,
veterans and other groups.

Private Calendar Events can include the following list. These calendars are solely for the
membership of the church - actual church members - and not the general public.

Days/Times when the pastor is maintaining office/counseling hours
Events with the detail for new member classes
Choir practices and performances
Facilities, e.g., sanctuary, Sunday School rooms, playground, reception/meeting halls,
kitchen, library, parking Lots, some cleaning equipment, organ, pianos, other musical
instruments.

Example uses:

As a church member, I want the ability to review all the public events at the church.
As a church member that is also a member of a sub-group, I want the ability to review all
the private events of the group:

As a choir member, I want to see all choir practice events and communicate to
the choir director and all other choir members with updates and/or additional
information about choir related information.
As a Sunday school teacher, I want to be able to create and update events that
communicate to all of the members in our Sunday school class.
As a Church administrator, I want to be able to add and delete members to
private calendars.
As a Boy Scout troop leader, I want to be able to create, update and maintain the
Boy Scout troop calendar which includes the church administrator as a calendar
administrator.

As a Church administrator, I want to be able to create, update and maintain all public
and some private calendars.
As a church pastor, I want to be able to create, update and maintain all public and all
private calendars.
As a Church administrator, pastor or other delegate by the previous, I want to be able to
create, update and maintain facilities calendars.

As seen above, embodiments of the invention enable various individuals, groups, and sub-
groups to have different privileges, responsibilities, and abilities with regard to a single activity
type, i.e., church. Thus, one calendar (or, if desired, multiple calendars) can be used to facilitate
planning, scheduling, and logistics, while maintaining the levels of privacy desired for each type
of activity.

| | |
|---|---|
| | Description: Consider a group of young |
| | sorority members who are active in several |
| | clubs and school events. The students need a |
| | way to keep up with all public & private |
| | meetings and events, as well as keep track of |
| Title: Sorority | private events with friends. |

Details:

| | |
|---|---|
| 1. | Sorority's public calendar keeps track of events hosted by the Sorority. These events could |
| | be attended by people who are not in the Sorority, and are therefore searchable through |
| | the e-calendar system. This could be especially useful during Rush (recruitment of new |
| | members at beginning of each year). Only calendar owner and members with the right |
| | permissions can add events. |
| 2. | Sorority's private calendar includes events hosted by the Sorority that are only for members |
| | of the Sorority. This calendar would only be seen and searchable by calendar subscribers. |
| | Calendar owner can decide who can add event - allowing all subscribers to add event is an |
| | option. |
| 3. | Smaller group within Sorority creates another private BFF Calendar to plan events with |
| | closest friends (2-10 people). Can see which friends in groups are attending which event, and |
| | can chat about event on calendar. Subscribers can add pictures, video, information to any |
| | event. Calendar owner can decide who can add event - allowing all subscribers to add event |
| | is an option. |
| 4. | One student also joined University's Panhellenic Council. The group has a private calendar |
| | where it lists meetings, events and deadlines. The student adds this calendar, because she |
| | has to attend every event. |
| 5. | Another student wants to keep up with University's athletic events, so she adds the |
| | public University Athletics Calendar. This includes all sports (3-4 daily), but student will not |
| | attend all. She may share some events on the private Sorority calendar so other members of |
| | the group know about them and can attend. |
| 6. | Student also uses public University Football Calendar, which includes all football games. |
| | Student can share football game event with friends on private BFF calendar, then chat about |
| | what time they're going to meet, etc. |

References and Notes:

A BFF calendar would be unique. Instead of planning things through “group text
messages,” there would be one place where the group could primarily plan events
together, but also interact about future and past events.

| | |
|---|---|
| | Description: |
| | During Hospital stays, individuals want to know |
| | the latest, information including, when and |
| | what doctors are coming and what they are |
| | saying, when caretakers are taking turns |
| | staying during the day and night, and what |
| | they are all doing and finding out each day. |
| | Embodiments of the e-calendar system can be |
| Title: Hospital Stays | used to coordinate such things |

Details:

| | |
|---|---|
| 1. | Home-cooked meals. Families can create a family and friends calendar and share when |
| | and what they may be cooking, such that extra food or meals could be cooked and |
| | shared among the group. The cook could put the event on the calendar, saying what |
| | they care cooking and about how much could be cooked if others want some, and the |
| | chat feature allows pictures and videos and communication among the group |
| | coordinating the event. Also a detailed record is recorded, so that credit is allowed, and |
| | others can perform similar acts to equal out the bargain. |
| 2. | If a person schedules family care givers to be present at certain times the gps could tell |
| | the person that they were close and coming and then here. Later, when the person |
| | looks at the record, he can look back and see they were here from this time to this time. |
| | Plus, the invention app allows users to make corrections on the fly and have peace of |
| | mind. |

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A system for viewing and managing a collection of electronic calendars of a user, comprising:
an interface that enables the user to browse through the collection of electronic calendars and add or remove electronic calendars from the collection of electronic calendars; and
a permissions set that enables an owner of a particular electronic calendar to allow others to at least one of view, add to, share, and edit the particular electronic calendar.

2. The system of claim 1, wherein the system enables multiple users to link an event to multiple calendars, users with edit permissions to make changes to the event, and the changes made to the event to appear in all the calendars that link to that event.

3. The system of claim 1, wherein the permissions set further enables an owner of the particular electronic calendar to permit users with which the owner shared the particular electronic calendar to at least one of further share the particular electronic calendar with a third party and set permissions for the third party.

4. The system of claim 1, wherein the permissions set further enables one of (i) an owner of the particular electronic calendar, or (ii) another individual with requisite permissions to set specific permissions for each individual event in the calendar.

5. The system of claim 1, wherein the particular electronic calendar is present in collections of calendars of a plurality of users, and wherein a modification to the particular electronic calendar is automatically reflected in each calendar of the collections of calendars of the plurality of users.

6. The system of claim 1, further comprising:
a notification component that includes various levels of notification based upon an importance of a calendar update.

7. The system of claim 1, further comprising:
an ETA component that updates attendees of a meeting with location information of other attendees of the meeting.

8. The system of claim 1, further comprising:
a chat component that enables users with requisite permissions to discuss an event or multiple events on the electronic calendar.

9. The system of claim 1, wherein the electronic calendars comprise public electronic calendars and private electronic calendars.

10. The system of claim 9, wherein public calendars are searchable by the general public.

11. A system for viewing and managing a collection of electronic calendars of a user, comprising:
an interface that enables the user to browse through the collection of electronic calendars and add or remove electronic calendars from the user collection of the user; and
a permissions set that enables an owner of a particular electronic calendar to allow others to:
view the particular electronic calendar,
add to the particular electronic calendar,
view and add to the particular calendar,
view and share the particular electronic calendar,
view, add to, and share the particular electronic calendar,
view, add to, and edit the particular electronic calendar, or
view, add to, share, and edit the particular electronic calendar.

12. The system of claim 11, further comprising:
a default permission,
wherein the default permission allows users to view, add to, and share the particular electronic calendar.

13. A system for viewing and managing a collection of electronic calendars of a user, comprising:
an interface that enables the user to browse through the collection of electronic calendars and add or remove electronic calendars from the collection; and permissions set that enables an owner of a particular electronic calendar to allow others to:
view the particular electronic calendar,
view and add to the particular calendar,
view and share the particular electronic calendar,
view, add to, and share the particular electronic calendar,
view, add to, and edit the particular electronic calendar, or
view, add to, share, and edit the particular electronic calendar.

14. The system of claim 13, further comprising:
a default permission,
wherein the default permission allows users to view and share the particular electronic calendar.

15. The system of claim 13, wherein the particular electronic calendar is searchable by the general public.

16. The system of claim 14, wherein the particular electronic calendar is searchable by the general public.
